(19) United States
(12) Patent Application Publication
(10) Pub. No.: US 2008/0104272 A1
(43) Pub. Date: May 1, 2008

(54) METHOD AND SYSTEM FOR ROUTING A MESSAGE OVER A HOME NETWORK

(76) Inventor: Robert P. Morris, Cary, NC (US)

Correspondence Address: SCENERA RESEARCH, LLC, 111 CORNING RD., SUITE 220, CARY, NC, 27511, US

(21) Appl. No.: 11/555,248

(22) Filed: Oct. 31, 2006

(51) Int. Cl. G06F 15/16; G06F 15/173

(52) U.S. Cl. 709/238; 709/228

(57) ABSTRACT

A method and system are described for routing messages over a home network. In one aspect of the subject matter disclosed herein, a method for routing a message over a home network is described. The method includes establishing a relationship between a home network appliance class and a home network service, wherein the home network appliance class identifies a class of home network appliances operable within a home network environment. The method further includes receiving over a home network from a sending home network appliance, a message identifying a home network appliance class for the sending home network appliance. The method also includes determining, based on the established relationship, a home network service related to the home network appliance class. The method further includes routing the message to the determined home network service via the home network.

### BACKGROUND

Computing is becoming more and more ubiquitous. Not only do PC's, laptops, and handheld computing devices have processors, but most audio/video equipment, appliances, automobiles, etc., have one or more processors as well. Many of these devices have no display, or provide a display on the device that is small. Few devices provide remote user interfaces. Integrating all this computing power has been a problem of interest for some time. For example a common home may include a television, a digital video recorder (DVR), a desktop computer, multiple kitchen appliances, a refrigerator, and a washer and dryer. Each of these devices can be networked and each includes a processor.

However, these devices do not communicate for the most part. In the above home system, there is no way for the refrigerator to communicate with the television. Further, today's systems lack a dominating standard for communicating. Each of the proposed standards has its own complexities that make interoperability a problem.

Accordingly, there exists a need for methods, systems, and computer program products for routing a message over a home network.

### SUMMARY

In one aspect of the subject matter disclosed herein, a method for routing a message over a home network is described. The method includes establishing a relationship between a home network appliance class and a home network service, wherein the home network appliance class identifies a class of home network appliances operable within a home network environment. The method further includes receiving over a home network from a sending home network appliance, a message identifying a home network appliance class for the sending home network appliance. The method also includes determining, based on the established relationship, a home network service related to the home network appliance class. The method further includes routing the message to the determined home network service via the home network.

In another aspect of the subject matter disclosed herein, a system for routing a message over a home network is described. The system includes a relationship manager configured to establish a relationship between a home network appliance class and a home network service, wherein the home network appliance class identifies a class of home network appliances operable within a home network environment. The system also includes a message router configured to receive over a home network from a sending home network appliance, a message identifying a home network appliance class for the sending home network appliance. The system further includes a traversal engine configured to determine, based on the established relationship, a home network service related to the home network appliance class. The message router is further configured to route the received message to the determined home network service via the home network.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

As used herein, “Network Client” means a role played by a device, executable, and/or other resource coupled to the network where the role involves sending a message which is routed to a service.

As used herein, a “Relationship” is an association between or among a plurality of network resources. A relationship may be predefined by a manufacturer, reseller, and/or installer, for example, including an owner or other user of a network resource. A relationship may be defined dynamically as network devices register themselves and optionally register class records needed by the network resource. In its most basic embodiment, a relationship is simply a link from one record or tuple to another record or tuple. Relationships may be unidirectional or bidirectional. Relationships may be typed or categorized with each type or category associated with information specific to the type or category. Relationships may have cardinality constraints including support for one-to-one, one-to-many, many-to-many, and/or m-to-n relationships where ‘m’ and ‘n’ are configurable for any given relationship or type of relationship. Some embodiments may support additional data associated with a relationship, such as typed relationships previously mentioned. The associated data may include information used by a traversal engine in filtering paths to traverse, saving the cost of traversing all paths in search of a best match.

As used herein, a “Service” is a role played by a device, executable, and/or other resource coupled to a network, which receives a message and provides a function, fulfills a request, or processes a command based on the message.

As used herein, a “Class” is a type or category associated with a network resource. Since a network resource may play at least one of the roles of a network client and a service, a class may be associated with a network client and/or a service. A network resource may be associated with zero or more classes. A class may identify a type of network resource; an operational mode or role of a network resource; a data type transmitted by and/or processed by a network resource; for example. A class may be predefined by a manufacturer, reseller, and/or installer, for example, including an owner or other user of a network resource.

Thus, the subject matter described herein can be embodied in many different forms, and all such forms are contemplated to be within the scope of what is claimed.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a flowchart illustrating an exemplary method for routing a message over a home network, according to an exemplary embodiment;

FIG. 2 illustrates an exemplary system for routing a message over a home network, according to an exemplary embodiment;

FIG. 3 illustrates an exemplary system for routing a message over a home network, according to an exemplary embodiment;

FIG. 4 is a message flow diagram illustrating an exemplary message flow in routing a message over a home network, according to an exemplary embodiment;

FIG. 5 illustrates an exemplary system for routing a message over a home network, according to an exemplary embodiment;

FIG. 6 is a message flow diagram illustrating an exemplary message flow in routing a message over a home network, according to an exemplary embodiment; and

FIG. 7 illustrates an exemplary display for displaying a message routed over a home network, according to an exemplary embodiment.

### DETAILED DESCRIPTION

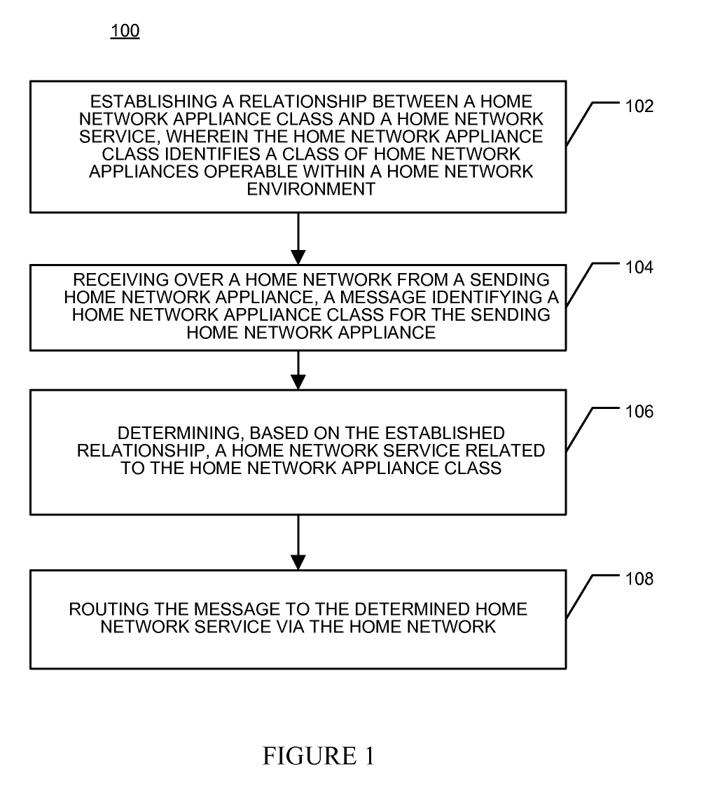

According to one aspect, the subject matter described herein includes a system and method for routing a message over a home network. FIG. 1 illustrates an exemplary method 100 for routing a message over a home network. The method allows a network client to send a message to a network service without knowing an address of the network service. The network service is located using one or more established relationships specified between or among a set of network resources and or network resource classes.

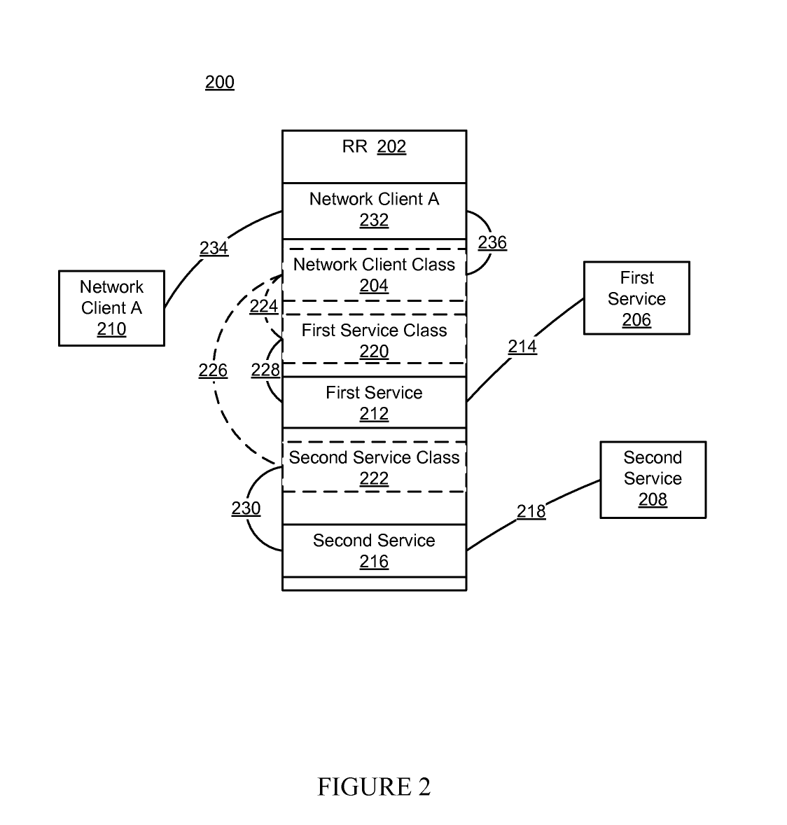

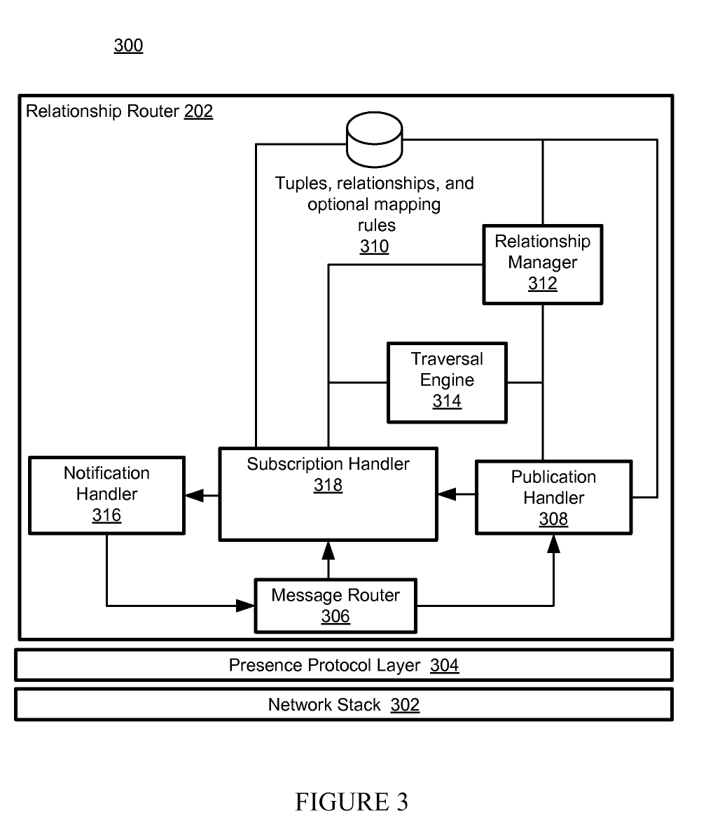

For example, FIG. 2 depicts an exemplary system 200 using a server referred to as a relationship router (RR) 202 for enabling the operation of the method 100 from a network component level view. The system 300 depicted in FIG. 3 illustrates a detailed exemplary embodiment of a relationship router 202 based upon a real-time publish-subscribe server of which a presence server is one embodiment.

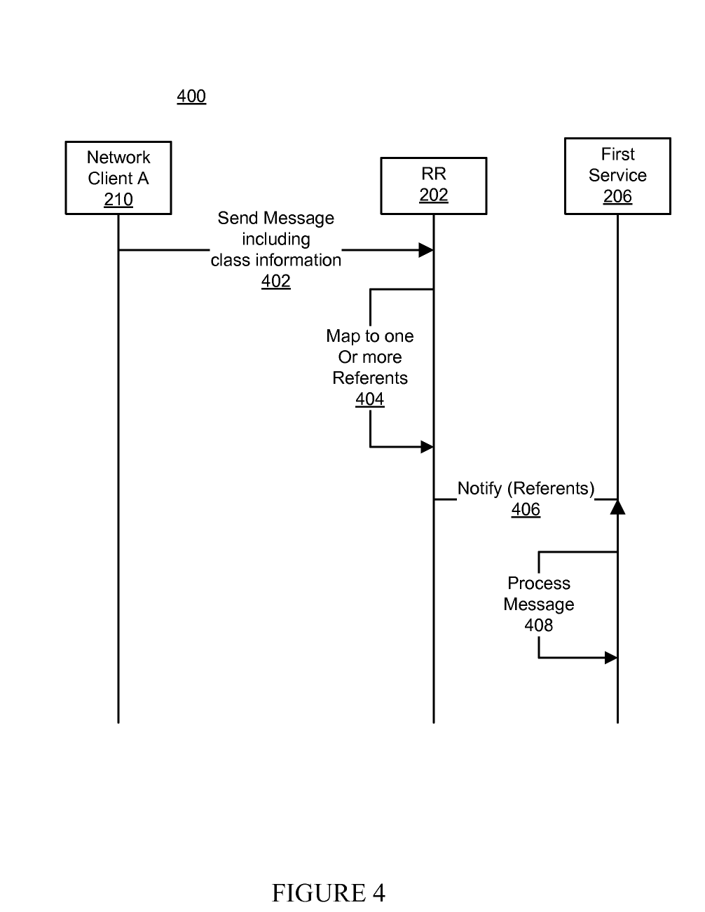

FIG. 4 depicts a message flow diagram 400 illustrating an exemplary message flow among the network components of the system 200. An embodiment of the method 100 in FIG. 1 is described herein in terms of the systems 200 and 300, and the message flow diagram 400 in FIG. 2, FIG. 3, and FIG. 4, respectively.

At block 102 the method 100 establishes a relationship between a home network appliance class and a home network service, wherein the home network appliance class identifies a class of home network appliances operable within a home network environment. For example, a network client, such as a home network appliance, is associated with a class based on an attribute of the network client. Attributes of the network client used to associate the network client with a class can include the current mode of the network client or the function or service the network client is currently attempting to provide. One or more relationships are established associating the class with one or more network resources. The class identifies a category or type of network client operable within a network such as a home network, a business network, or the Internet. In an embodiment, the method 100 includes associating presence information for a principal associated with the sending home network appliance and a principal associated with the home network service in establishing a relationship between a home network appliance class and a home network service.

A system for routing a message over a home network can accomplish the method 100. The system includes means for establishing a relationship between a home network appliance class and a home network service, wherein the home network appliance class identifies a class of home network appliances operable within a home network environment. For example, the system 200 in FIG. 2 depicts a relationship router 202. The relationship router 202 in one embodiment includes a network client class record 204 identified by a class identifier provided by, for example, a manufacturer, reseller, or installer. In the embodiment described, the network client class record 204 includes service information identifying one or more services that may be of use to the class of network clients associated with the network client class record 204.

Also depicted in system 200 is a provider of a first service 206, a provider of a second service 208, and a particular network client, network client A 210, all coupled to the network (not shown) as is the relationship router 202. As discussed above, a service is a role played by a device, executable, and/or other resource coupled to a network, which receives a message and provides a function, fulfills a request, or processes a command based on the message. The first service 206, in one embodiment, locates the relationship router 202 when the first service 206 connects to the network. The relationship router 202 may be located by the first service 206 in a number of ways according to the specific embodiment. For example, relationship router 202 is located via a service record in a DNS server in one embodiment, by listening for a broadcast over the network from the relationship router 202 in another embodiment, issuing a broadcast command by the first service 206 in yet another, or by having the address of the relationship router 202 provided by a DHCP server in response to the device of the first service 206 requesting a network address in still another embodiment. Once located, the first service 206 registers with the relationship router 202 where the registration information includes a service description. The relationship router 202 stores the registration information for the first service 206 in a record, a first service record 212. The existence of the first service record establishes a relationship 214 between the first service record 212 and the first service 206. In one embodiment, the relationship router 202 matches the service information in the network client class record 204 with the service description in the first service record 212. If the relationship router 202 determines a match exists the relationship router establishes a relationship between the network client class record 204 and the first service record 212.

The second service 208 is registered similarly resulting in the creation of a second service record 216 and, thus, a relationship 218 between the record and the service 208. If the relationship router 202 determines a match exists between the service description of the second service record 216 and the service information of the network client class record 204, a relationship between the two records is established.

In an exemplary embodiment, as depicted in system 200, relationship router 202 includes one or more class records provided by, for example, a manufacturer, reseller, or installer. In the example, class records are provided for the class of the first network service 206 shown as a first service class record 220 and the class of the second network service 208 shown as a second service class record 222. Further, the manufacture, reseller, and/or installer, for example, establishes a relationship 224 between the network client class record 204 and the first service class record 220, and a relationship 226 between the network client class record 204 and the second service class record 222. For example, the home network appliance class is pre-associated with the sending home network appliance in connection with at least one of manufacturing, installation, and sale of the sending home network appliance, prior to connection of the sending home network appliance to the home network.

In the exemplary embodiment, when a network service registers with the relationship router 202, the relationship router 202 uses the service information in the network services record to locate one or more class records that match. When a match is found, a relationship is established between the network service record and the service class record. In system 200, relationship router 202 determines that a match exists between first service record 212 and the first service class record 220 and establishes relationship 228 as a result. Similarly, relationship router 202 determines that a match exists between the first service record 216 and the second service class record 222 and establishes relationship 230.

Network client A 210 registers with the relationship router 202 as other network clients and services already described. Network client A's 210 registration causes relationship router 202 to create a record including client information shown as network client A record 232. The existence of network client A record 232 establishes a relationship 234 between network client A 210 and network client A record 232. In the embodiment described, the client information in network client A record 232 includes class information identifying one or more classes to which network client A 210 belongs. The relationship router 202 uses the class information included in the client information to locate one or more matching network client class records. In system 200, the relationship router 202 determines a match exists between the class information in network client A record 232 and network client class 204. As a result, the relationship router 202 establishes relationship 236 as a result of the match.

At block 104 the method 100 receives over a home network from a sending home network appliance, a message identifying a home network appliance class for the sending home network appliance. A system for routing a message over a home network can accomplish the method 100, the system includes means for receiving over a home network from a sending home network appliance, a message identifying a home network appliance class for the sending home network appliance. For example, network client A 210 in system 200 sends a message to the relationship router 202. The message identifies a class for a sending network client. In one embodiment, the message is addressed to or associated with the network client class record 204 by including the class identifier in the message. In the exemplary embodiment, the message is addressed or associated with the network client A record 232 by including the record identifier in the message or by the relationship router 202 using information in the record and the message to make the association. For example, an IP address may be used in cases where network client A 210 has a fixed address. The established relationship 236 between network client A record 232 and network client class 204 is used to identify an associated service class 220 as a result of the message. In an embodiment, the home network appliance class is included in a uniform resource locator (URL) destination identifier for the message. In an embodiment, the home network appliance class is identified by a token issued by a token authority. The receiving of the message is depicted in message flow diagram 400 in FIG. 4 as the publish message 402 from network client A 210 to the relationship router 202.

System 300 in FIG. 3 illustrates one particular embodiment of the relationship router 202 based on a presence service platform. The presence protocol described herein includes terms defined by RFC 2778 entitled A Model for Presence and Instant Messaging the entirety of which is incorporated by reference. In the described example, the message is received by a network stack 302 which processes and removes the various protocol headers and trailers of each protocol layer of the stack and routes the message to a presence protocol layer 304 based on a port number in the case where the network stack 302 is a TCP/IP stack. The Presence protocol layer 304 may further process the message and pass the message to a message router 306 within the relationship router 202. In the example described, first network client A 210 in system 200 is a presence client and the message includes a publish command. The message router 306 routes messages for processing based on a command type included in the message. In the case of a publish command, the message router 306 passes the message to a publication handler 308. The publication handler using an identifier included in the message attempts to locate a tuple/record associated with the publisher, the first network client A 210 in this example, in a tuple storage medium such as a tuple database 310. The tuple database 310 includes a variety of tuples. For example, a tuple corresponding to the home network appliance class or the home network service is stored in the tuple database 310. This tuple includes presence information for a principal of a publishing home network device. In an embodiment, the presence information stored in the corresponding tuple is at least one of published-to and subscribed-to by at least one agent associated with the home network appliance class or the home network service.

As described, when no tuple is located a tuple is created, network client A record 232, and associated with the sending presentity of the message, first network client A's 210 presentity (not shown). The created tuple is created based on information included in the message including the publish command. If a tuple is located, the located tuple is updated based on information included in the message including the publish command.

A relationship manager 312 is used to perform the matching described earlier and establishes the relationships also previously described. In the depicted embodiment, each relationship is stored in the database 310. For example, one or more link tables can be created in the database 310 where each record in a link table identifies the records associated by a relationship represented by the record. In this case, a record in a link table is created by the relationship manager 312 for the relationships 224, 226, 228, 230, and 236 depicted in system 200 and described earlier. Network client and service records define respective relationships with their associated network clients and services, typically, by the relationship router 202 providing an identifier of the record to the associated client and/or service, and the client or service providing addressing information in what was referred to earlier as a register command which in the case of system 300 is embodied by a publish command.

The relationship manager 312 is also enabled to determine the relationships associated with a record. In an embodiment, a traversal engine 314 is used by the relationship router 202 to identify one or more class records associated with a client class when a message is published to a client record such as network client A record 232. The traversal engine 314 uses one or more mapping rules to identify a client class record. In a simple embodiment, a mapping rule is provided that causes the traversal engine 314 to identify all class records associated with a network client record. In other embodiments, information including at least one of the message, the client class record, and the client record is used by the traversal engine 314 to determine appropriate class records, which are referred to as “best match” records based on the one or more mapping rules that are applied. A mapping rule may be stored in or coded into a traversal engine and/or may be stored in a data store allowing them to be altered as needed. In system 300 at least a portion of the mapping rules are stored in the database 310.

At block 106 the method 100 determines, based on the established relationship, a home network service related to the home network appliance class. As described above a system for routing a message can accomplish method 100. The system includes means for determining, based on the established relationship, a home network service related to the home network appliance class. For example, a traversal engine can be configured to determine, based on the established relationship, a home network service related to the home network appliance class. For example, in the system 200 in FIG. 2, the network client class record 204 is included in two established relationships; the relationship 224 with the first service class record 220, and the relationship 226 with the second service class record 222. When a record is located via a relationship, the remaining relationships of the record further identify another record or endpoint that is used depending on the embodiment to locate a service related to the class of the network appliance. Thus, in the system 200 the relationship 228 from the first service class record 220 leads to the first service record 212 which is associated with the first network service 206; and the relationship 230 leads to the first service record 216 which is associated with the second network service 208.

The relationship manager 312 is used to identify relationships for the traversal engine 314 to consider in applying the mapping rules stored in database 310 for the purpose of determining one or more “best match” services. In an embodiment, the relationship router 202 uses all relationships identified by the relationship manager 312 to determine all the paths from a client class record to an associated network service. That is, all the paths are “best match” paths. In other embodiments, the mapping rules identify one or paths based on information including at least one of the message, the client class record, and the client record. For example, in one embodiment a message is associated with data, which has a MIME type included in the message. Mapping rules are provided that associate particular MIME types with particular services. A message including the MIME type, text/html, is mapped to a browser service for display by a provided mapping rule. A message including a MIME type identifying the associated data as PostScript data is associated with a PostScript capable printer service. In another example, mapping rules are based on a class of a network client sending a message and a class of a network service. For example, a message from a network client associated with a DVR class record is always associated with a service associated in a display class record. The relationship between the two class records is specified by at least one of a manufacturer, reseller, and installer of the at least one of the network client, the RR, and the service involved. Other information that is used in some situations in association with a mapping rule includes status information of a client or a service, the status of related network resources, and/or an operation identifier provided in a message. The examples of information described applicable to mapping rules used by a traversal engine are not exhaustive.

The process of determining a service based on the established relationships is depicted in system 400 as a message to apply the mapping rules 404 in database 310 by traversal engine 314.

At block 108 the method 100 routes the message to the determined home network service via the home network. As described above a system for routing a message can accomplish method 100. The system includes means for routing the received message to the determined home network service via the home network. For example, a message router can be configured to route the received message to the determined home network service via the home network. For example, in the system 200 in the embodiment where all paths from a network client record to a service via a class record are “best match” paths, the message is sent to all network services located by the traversal engine 314. In this case, when network client A 210 sends a message to the relationship router 202 the traversal engine 314 identifies both the first network service 206 and the second network service 208. In one embodiment, the traversal engine 314 causes the notification handler 316 to create a notification based on the received message addressed to both the first network service 206 and the second network service 208. The notification handler 316 sends the notifications to the two services via the message router 306, the presence protocol layer 304, and the network stack 302 over the network (not shown). In an embodiment, the home network service is a client application on a home network appliance. In an embodiment, the message includes presentation information for display by the home network service. In an embodiment depicted in the message flow diagram 400 the message is shown as a notify message 406.

Each service determines how to process the message based on information included in the message such as a content type, a command, and/or an attribute of the service such as the current state or a security parameter. Processing in some cases involves processing at least a portion of the message content only. In other cases, a service uses location information in the message to locate a network resource such as the sending network client, establish communication, and interoperate in order to provide the service. The processing described is shown as a message 408 to process the message 402 in system 400.

As described above other mapping rules cause the traversal engine 314 to identify a subset of the services for which a path exists from the network client record of the sender to all the services connected by a path of relationships.

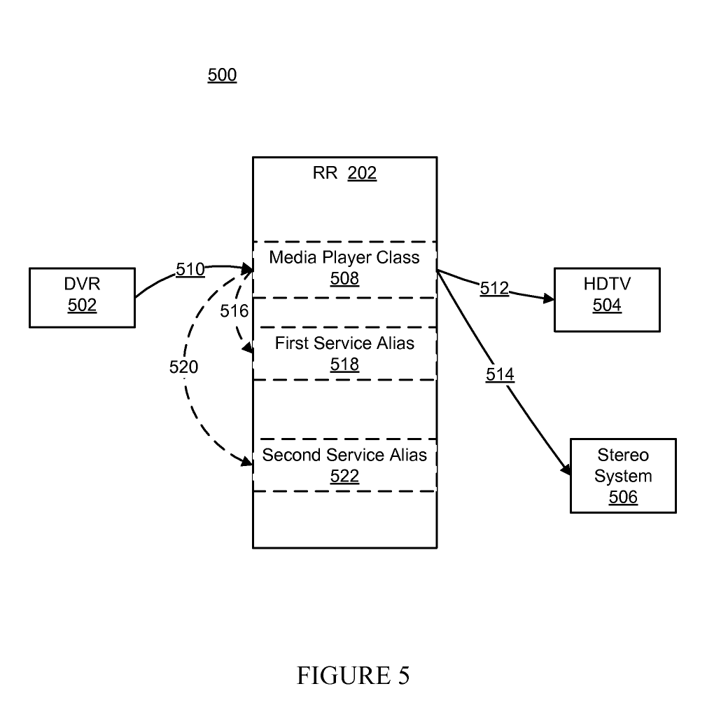

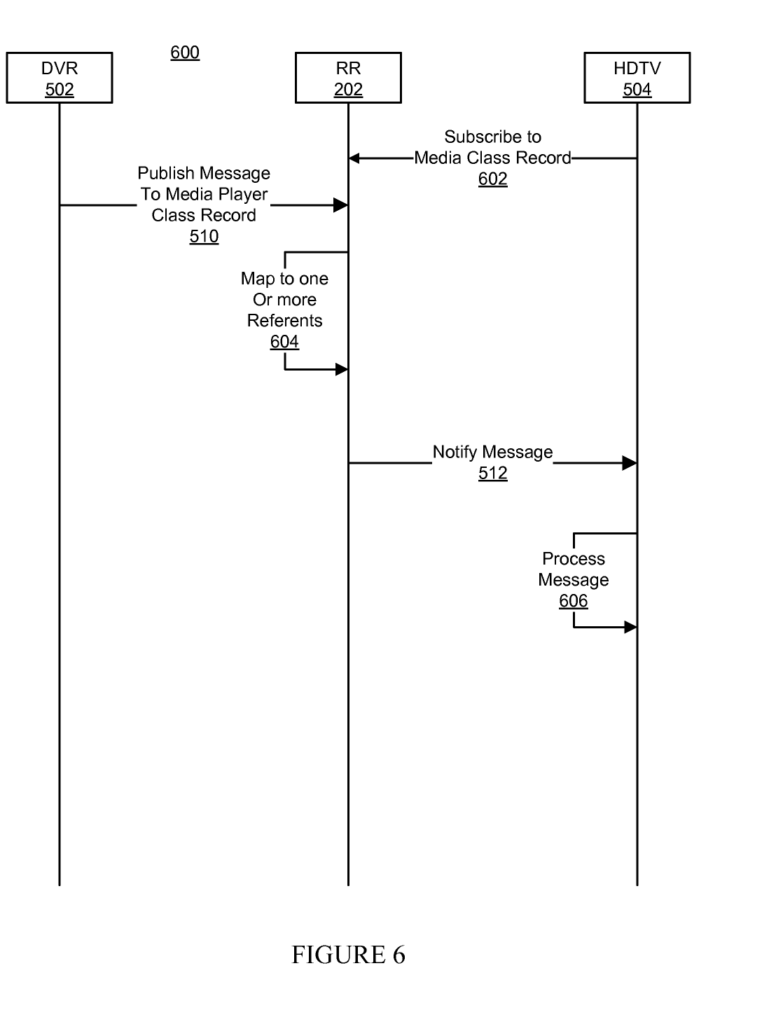

FIG. 5 depicts system 500, an alternate embodiment for carrying out the method 100, where the relationship router 202 does not maintain records for the various network resources shown as the network client, DVR 502, and services provided by an HDTV 504 and a stereo system 506. The relationship router 202 maintains only class records. System 500 depicts one class record, a media player class record 508, representing all network resources capable of presenting at least one form of media including media, audio, and still image data. Each of the DVR 502, the HDTV 504, the stereo system 506, and the media player class record is preconfigured with an identifier of the media player class record 508 by, for example, a manufacturer, reseller, and/or installer. Network resources that provide services associated with a media class subscribe to events associated with the media player class record 508. Thus, the HDTV 504 and the stereo system 506 each have subscriptions associated with the media class player record 508. A message subscribing to the media player class record 508 is shown as message 602 in the message flow diagram 600 in FIG. 6.

When the DVR 502 enters play mode, the DVR 502 sends a message 510 over a network (not shown) including the preconfigured identifier of the media player class record 508 to the relationship router 202. The message 510 is also depicted in the message flow diagram 600 in FIG. 6. Based on information in the message, the traversal engine 314, for example, in the relationship router 202 identifies both the HDTV 504 and the stereo system 506 as recipients of the message. For example, the message 510 from the DVR 502 includes MIME type information indicating both the DVR 502 has both video content and audio content to play. This is depicted as a message to determine related services shown as a message 604 to the traversal engine 314 in the message flow diagram 600 for identifying the related resources.

An event or notification is generated based on the message 510, for example by subscription handler 318 invoking notification handler 316 in the case of the presence based embodiment of relationship router 202 in system 300. Events or notifications are sent over the network to the identified network resources including at least a portion of the subscribers to the media player class record 508 providing the needed services. A notification 512 sent to the HDTV 504 shown in system 500 and message flow diagram 600 and a notification 514 the stereo system 506 shown in system 500. In one embodiment, this establishes a path through the relationship router through which the content from the DVR 502 is routed.

In an exemplary embodiment, the message 510 includes location information allowing the HDTV 504 and the stereo system 506 to establish communications directly over the network (not shown) with the DVR 502 enabling the playing of a video stream by the HDTV 504 and an audio stream by the stereo system 506. The DVR 502 may synchronize the two media streams based on information provided from the two services. Alternatively, at least one of the HDTV 504 and the stereo system 506 sends a message (not shown) to the media class player record 508 in relationship router 202. The message indicates a need for a synchronization service. Based on mapping rules and information included, for example, in at least one of the subscriptions of the HDTV 504 and the stereo system 506 and the message (not shown), the message is routed to one of the two services based on the identity of the sender. This allows the receiver to establish communication with the sender of the request for synchronization service allowing the two services to interoperate in order to enable synchronization of the playing of the two streams. The processing of the notification 512 by the HDTV 504 is shown as a message 606 to process the notification 512 in the message flow diagram 600.

In an alternate embodiment, the relationship router 202 in the system 500 in FIG. 5 is preconfigured with a set of aliases known to the providers and/or administrator of the HDTV 504 and the stereo system 506. The relationship router 202 also includes preestablished relationships such as relationship 516 between the media class player record 508 and the first service alias 518 whose identifier is known to the HDTV 504. Using the first service alias identifier, the HDTV 504 subscribes to notifications associated with the first service alias 518 maintained by the relationship router 202. In this manner, the HDTV 504 is enabled to be related to a class record, such as media class player record 508, without the HDTV 504 knowing the class identifier of the media class player record 508. Analogously, in the example, the relationship router 202 also includes a preestablished relationship 520 between the media class player record 508 and a second service alias 522 known to the stereo system 506. As with the HDTV 504, the second service alias 520 enables the stereo system 506 to be related to the DVR via the media player class record 508 without requiring the stereo system 506 to have any knowledge of the media player class via a subscription established by the stereo system 506 with the relationship router 202 using the second service alias identifier. Notifications are routed to one or both of the HDTV 504 and stereo system 506 in a manner analogous to the manner previously described using only the media class player record 508

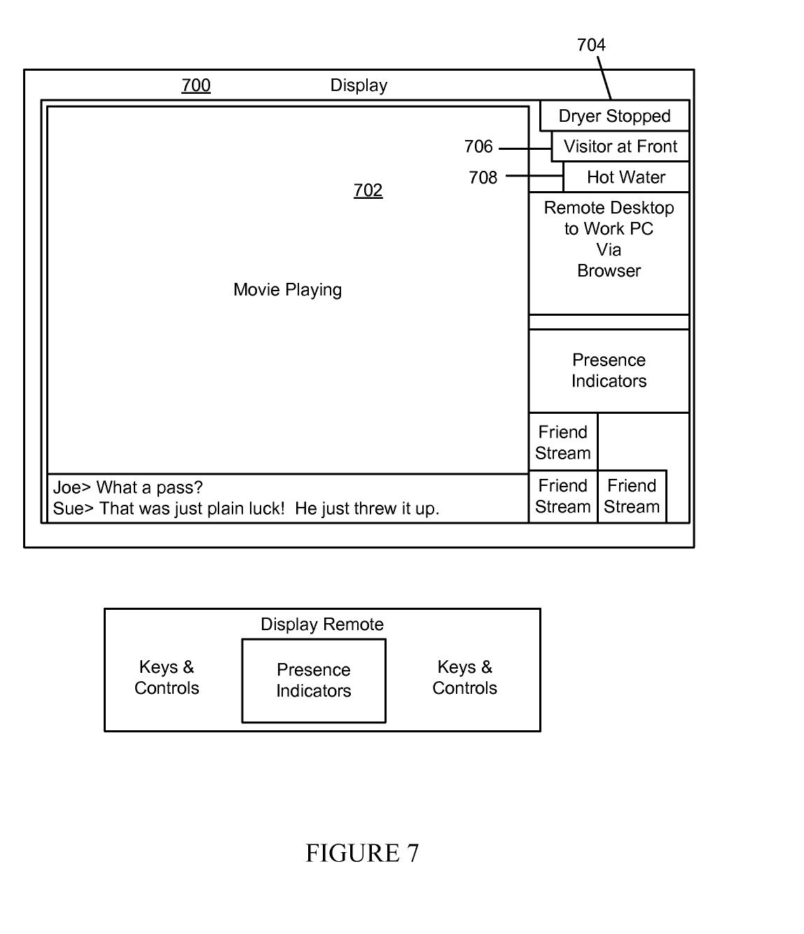

FIG. 7 shows an example display device 700 where a variety of clients have published messages to a RR and through an established relationship the message is routed to the display and/or the remote control allowing the client devices to have their content displayed. For example, display device 700 includes a variety of sections of the display for presenting received messages. In section 702, the display's main purpose is to play a movie. In sections 704, 706, and 708 messages from the home network are displayed. In section 704 a message sent from the dryer indicating that it has stopped operating is displayed. In section 706 a message sent from the home security system indicating that someone is present at the front door is displayed. In section 708 a message sent from the hot water heater indicating that hot water is low is displayed.

In one use of an embodiment, a client is enabled to send presentation information to presentation service. Each client provides its own presentation information while the service presents the information (much like a dumb terminal or web browser). The presentation service supports a number of well-known presentation formats including HTML, XUL, XAML, Flash, and various streaming formats including support for interactive streaming as illustrated in FIG. 7.

The presentation service depicted can also support one or more scripting engines for support of dynamic interfaces. The presentation service can additionally support new formats and proprietary formats, and can support service-side executables such as plug-ins, which the service can install on demand as needed. Additionally, the service supports cached executables and executables installed by a provider of the service such as a manufacturer.

In another embodiment, a combination of means is used to enable the method 100. In this embodiment, a network client device publishes presence information to a tuple associated with the client. A match is performed resulting in a relationship established between the client's tuple and a class tuple associated with the client based on information in the client tuple and a matching rule. Network resources acting in the role of services subscribe to class tuples associated with their respective services. Relationships between client class tuples and service class tuples are either predefined or defined when a new class tuple is added. Based on the relationships, the RR's traversal engine is enabled to determine paths between clients and related services. As a result, in one embodiment, the RR establishes subscriptions on behalf of the services to client tuples to which each service has a path. Thus, when a client publishes a message, a notification is sent to services subscribed to the tuple. Thus, the relationships are used only for setting up subscriptions.

In an alternate embodiment, a message flow where the mapping rules are enforced by one or more separate rule agents. This system is semi-distributed. One can easily see that pure peer-to-peer embodiments exist where at least one of clients and servers enforce at least a portion of the mapping rules for the network resources on the network.

In yet another alternate embodiment instead of publishing using a specified class identifier of a class tuple or record, the client sends a Subscribe message using the client class identifier. The relationship router uses relationships associated with the class record to traverse paths to possible services of use the client. The relationship router then notifies each service of the possible client. Each service then subscribes to the tuple of the client and/or the client class tuple depending on the embodiment enabling the service to receive message from the client.

In still yet another alternate message flow the client publishes to a class tuple using the class identifier. The relationship router returns a list of identifiers of related identifiers preset or predetermined prior to the publish message. Alternately the client may publish to its own tuple (update or create). Based on the information published the relationship router may dynamically determine one or more identifiers to return to the client in response to the publish or via a directed notify. The client with the service information returned as a result of the publish uses the information to communicate with one or more of the services either directly or through a proxy such as the relationship router.

As one skilled in the art can see, there are many possible message flows in routing a message over a home network. An embodiment where the information is routed through the relationship router has been shown; embodiments where the client may send the message directly or through a proxy have been described as alternatives. Classes of embodiments allowing a service to request the information from a proxy, the relationship router, or directly from a client also exists and flows supporting these classes of embodiments can be generated by one skilled in the art provided with the description given.

Another class of embodiments enables the service to initiate the receiving of the client information by the service by sending a request for the information to the client, relationship router, or other proxy. In one embodiment a service subscribes to a client class tuple to effectuate routing a message over a home network.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

1. A method for routing a message over a home network, the method comprising:
establishing a relationship between a home network appliance class and a home network service, wherein the home network appliance class identifies a class of home network appliances operable within a home network environment;
receiving over a home network from a sending home network appliance, a message identifying a home network appliance class for the sending home network appliance;
determining, based on the established relationship, a home network service related to the home network appliance class; and
routing the message to the determined home network service via the home network.

2. The method of claim 1 wherein the message includes presentation information for display by the home network service.

3. The method of claim 1 wherein the home network service is a client application on a home network appliance.

4. The method of claim 1 wherein the home network appliance class is included in a uniform resource locator (URL) destination identifier for the message.

5. The method of claim 1 wherein the home network appliance class is pre-associated with the sending home network appliance in connection with at least one of manufacturing, installation, and sale of the sending home network appliance.

6. The method of claim 1 wherein the home network appliance class is identified by a token defined by a token authority.

7. The method of claim 1 wherein the message received is sent using a presence protocol.

8. The method of claim 1 wherein the message is routed to the home network service using a presence protocol.

9. The method of claim 1 wherein establishing a relationship includes associating presence information with the sending home network appliance and with the home network service.

10. The method of claim 9 wherein the presence information is stored in a tuple corresponding to at least one of the home network appliance class and the home network service.

11. The method of claim 10 wherein the presence information stored in the corresponding tuple is at least one of published-to and subscribed-to by at least one agent associated with at least one of the home network appliance class and the home network service.

12. A system for routing a message over a home network, the system comprising:
a relationship manager configured to establish a relationship between a home network appliance class and a home network service, wherein the home network appliance class identifies a class of home network appliances operable within a home network environment;
a message router configured to receive over a home network from a sending home network appliance, a message identifying a home network appliance class for the sending home network appliance;
a traversal engine configured to determine, based on the established relationship, a home network service related to the home network appliance class; and
the message router configured to route the received message to the determined home network service via the home network.

13. The system of claim 12 wherein the message includes presentation information for display by the home network service.

14. The system of claim 12 wherein the home network appliance class is included in a uniform resource locator (URL) destination identifier for the message.

15. The system of claim 12 comprising a presence protocol layer configured to transfer a message using a presence protocol.

16. The system of claim 15 wherein the message router is configured to receive a message from the presence protocol layer sent using a presence protocol.

17. The system of claim 15 wherein the message router is configured to route the received message to the home network service using a presence protocol via the presence protocol layer.

18. The system of claim 12 comprising a tuple storage medium configured to store a tuple corresponding to at least one of the home network appliance class and the home network service.

19. The system of claim 18 comprising a publication handler configured to receive the message from the message router when the message includes a publish command, the publication handler also configured to update a tuple associated with the sending home network appliance in the tuple storage medium.

20. The system of claim 18 wherein the relationship manager is configured to associate presence information for a principal associated with the sending home network appliance and a principal associated with the home network service and for storing the presence information associated with the sending home network appliance in the tuple storage medium.

21. The system of claim 18 comprising a subscription handler configured to identify a subscriber to the tuple stored in the tuple storage medium.

22. The system of claim 21 comprising a notification handler configured to create a notification according to the received message for transmission to the identified subscriber.

23. A system for routing a message over a home network, the system comprising:
means for establishing a relationship between a home network appliance class and a home network service, wherein the home network appliance class identifies a class of home network appliances operable within a home network environment;
means for receiving over a home network from a sending home network appliance, a message identifying a home network appliance class for the sending home network appliance;
means for determining, based on the established relationship, a home network service related to the home network appliance class; and
means for routing the received message to the determined home network service via the home network.

24. A computer readable medium containing a computer program for routing a message over a home network, the computer program comprising executable instructions for:
establishing a relationship between a home network appliance class and a home network service, wherein the home network appliance class identifies a class of home network appliances operable within a home network environment;
receiving over a home network from a sending home network appliance, a message identifying a home network appliance class for the sending home network appliance;
determining, based on the established relationship, a home network service related to the home network appliance class; and routing the message to the determined home network service via the home network.
